(19) United States
(12) Patent Application Publication
(10) Pub. No.: US 2016/0372116 A1
(43) Pub. Date: Dec. 22, 2016

(54) VOICE AUTHENTICATION AND SPEECH RECOGNITION SYSTEM AND METHOD

(71) Applicant: AURAYA PTY LTD, Hornsby (AU)

(72) Inventor: Clive David SUMMERFIELD, Hornsby (AU)

(21) Appl. No.: 15/243,906

(22) Filed: Aug. 22, 2016

Related U.S. Application Data
(63) Continuation-in-part of application No. 14/374,225, filed on Jul. 23, 2014, now Pat. No. 9,424,837.

(30) Foreign Application Priority Data
Jan. 24, 2012 (AU) 2012900256
Aug. 19, 2016 (AU) 2016216737

(51) Int. Cl. G10L 17/04; G10L 17/06; G10L 25/63

(52) U.S. Cl. CPC G10L 17/04; G10L 25/63; G10L 17/06

(57) ABSTRACT

A method for configuring a speech recognition system comprises obtaining a speech sample utilised by a voice authentication system in a voice authentication process. The speech sample is processed to generate acoustic models for units of speech associated with the speech sample. The acoustic models are stored for subsequent use by the speech recognition system as part of a speech recognition process.

### CROSS REFERENCE TO RELATED APPLICATIONS

This application claims priority to Australia Application Number 2016216737 filed Aug. 19, 2016, and is a continuation-in-part of U.S. Ser. No. 14/374,225 filed Jul. 23, 2014, now U.S. Pat. No. 9,424,837 issued Aug. 23, 2016, which is a Section 371 National Stage of PCT/AU2013/000050 filed Jan. 23, 2013, which claims priority to Australia Application No. 2012900256 filed Jan. 24, 2012, all of which are incorporated herein by reference.

### FIELD OF THE INVENTION

This invention relates to the automatic tuning and configuration of a speech recognition system operating as part of a voice authentication system. The result is a system that both recognises the individual and recognises their speech.

### BACKGROUND OF THE INVENTION

The key to making effective speech recognition systems is the creation of acoustic models, grammars and language models that enable the underlying speech recognition technology to reliably recognise what is being said and to make some sense of or understand the speech given the context of the speech sample within the application. The process of creating acoustic models, grammars and language models involves collecting a database of speech samples (also commonly referred to as voice samples) which represent the way speakers interact with speech recognition system. To create the acoustic models, grammars and language models each speech sample in the database needs to be segmented and labelled into their word or phoneme constituent parts. Then the entire common constituent parts for all speakers (such as all speakers saying the word “two”, for example) are then compiled and processed to create the word (or phoneme) acoustic model for that constituent part. In large vocabulary phoneme based systems, the process also needs to be repeated to create the language and accent specific models and grammar for that linguistic market. Typically, around 1,000 to 2,000 examples of each word or phoneme (from each gender) are required to produce an acoustic model that can accurately recognise speech.

Developing speech recognition systems for any linguistic market is a data driven process. Without the speech data representative of the language and accent specific to that market the appropriate acoustic, grammar and language models cannot be produced. It follows that obtaining the necessary speech data (assuming it is available) and creating the appropriate language and accent specific models for a new linguistic market can be particularly time consuming and very costly.

It would be advantageous if there was provided a speech recognition system that could be automatically configured for any linguistic market in a cost effective manner.

### SUMMARY OF THE INVENTION

In accordance with a first aspect of the present invention there is provided a method for configuring a speech recognition system, the method comprising: identifying a user; selecting a training speech sample provided by the user, the training speech sample being associated with an emotional state of the user; processing a selected unit of speech from the training speech sample to generate a corresponding acoustic model; training a personalised acoustic model associated with the determined emotional state using the generated acoustic model, the personalised acoustic model being stored in an acoustic model store specific to the user; accessing the personalised acoustic model store to determine an emotional state of the user during a subsequent speech recognition process.

In accordance with a second aspect of the present invention there is provided a method for configuring a speech recognition system, the method comprising: identifying a user; selecting a training speech sample provided by the user, the training speech sample being associated with an emotional state of the user; processing the training speech sample to determine one or more phonemes or words therein; training a personalised grammar model associated with the determined emotional state utilising the determined phonemes or words, the personalised grammar model being stored in a model store specific to the user; accessing the personalised grammar model store to determine an emotional state of the user during a subsequent speech recognition process.

### BRIEF DESCRIPTION OF THE DRAWINGS

Features and advantages of the present invention will become apparent from the following description of embodiments thereof, by way of example only, with reference to the accompanying drawings, in which:

FIG. 1 is a block diagram of a system in accordance with an embodiment of the present invention;

FIG. 2 is a schematic of the individual modules implemented by the voice processing system of FIG. 1;

FIG. 3 is a schematic illustrating a process flow for creating voiceprints;

FIG. 4 is a schematic illustrating a process flow for providing speech recognition capability for the FIG. 1 system, in accordance with an embodiment of the invention;

FIG. 5 is a schematic illustrating a process flow for building speech recognition models and grammar, in accordance with an embodiment;

FIG. 6 is a schematic illustrating a process flow for providing user specific speech recognition capability for the FIG. 1 system, in accordance with an embodiment;

FIG. 7 is a block diagram of a system in accordance with a further embodiment;

FIG. 8 is a schematic of the individual modules implemented by the system of FIG. 7; and

FIG. 9 is a process flow for determining an emotional state of a user using the FIG. 7 system.

### DETAILED DESCRIPTION OF PREFERRED EMBODIMENTS

Embodiments utilise speech samples processed by a voice authentication system (also commonly referred to as voice biometric system) for automatically creating speech recognition models that can advantageously be utilised for providing added speech recognition capability. Since the generated models are based on samples provided by actual users of the system, the system is tuned to the users and is thus able to provide a high level of speech recognition accuracy for that population of users. This technique also obviates the need to purchase “add on” speech recognition solutions which are not only costly but can also be difficult to obtain, particularly for markets where speech databases suitable for creating the acoustic models, grammars and language models used by speech recognition technology are not available. Embodiments also relate to creating personalised speech recognition models for providing an even greater level of speech recognition accuracy for individual users of the system.

For the purposes of illustration, and with reference to the figures, embodiments of the invention will hereafter be described in the context of a voice processing system 102 which provides both voice authentication and speech recognition functions for a secure service 104, such as an interactive voice response (“IVR”) telephone banking service. In the illustrated embodiment, the voice processing system 102 is implemented independently of the secure service 104 (e.g. by a third party provider). In this embodiment, users of the secure service 104 communicate with the secure service 104 using an input device in the form of a telephone 106 (e.g. a standard telephone, mobile telephone or Internet Protocol (IP) based telephone service such as Skype™).

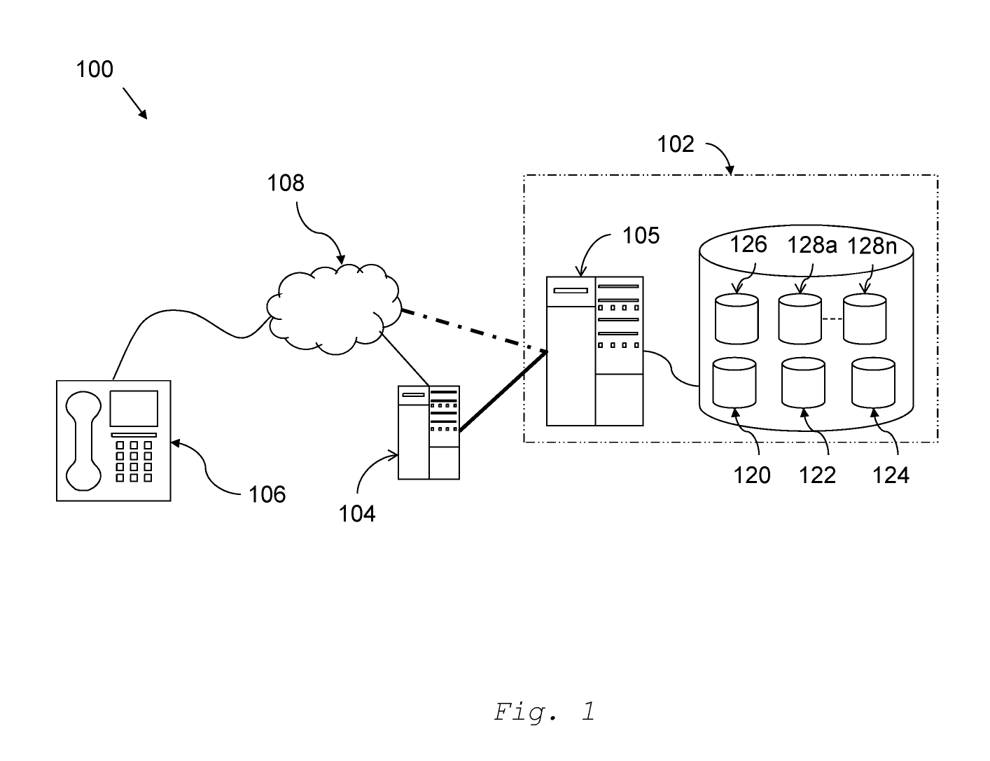

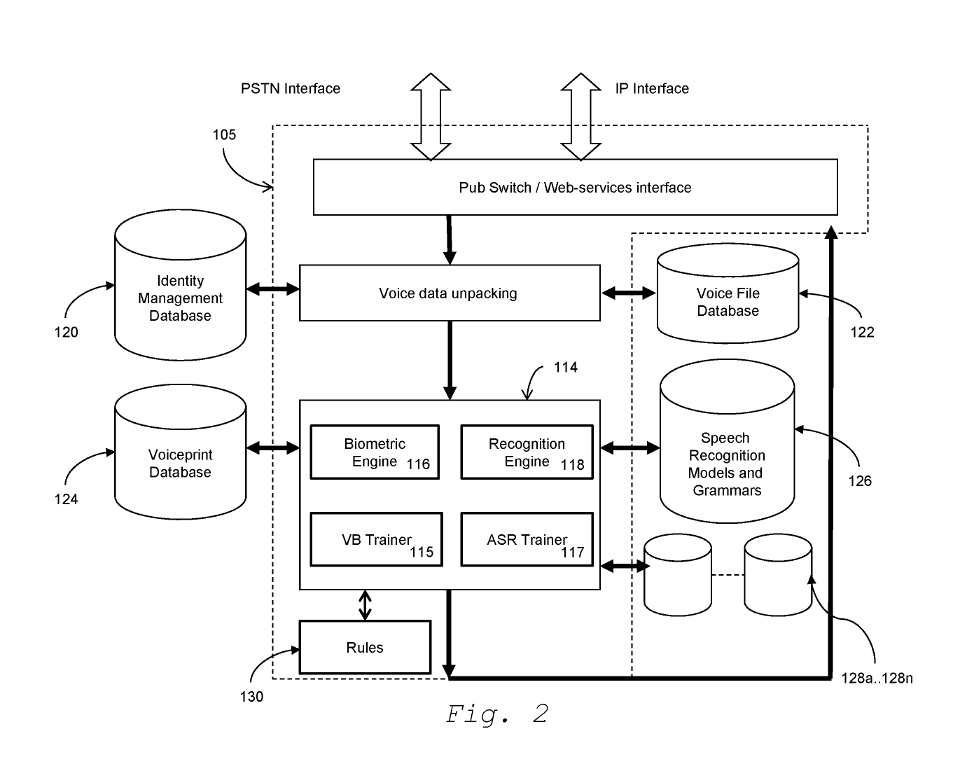

FIG. 1 illustrates an example system configuration 100 for implementing an embodiment of the present invention. As discussed above, users communicate with the telephone banking service 104 using a telephone 106. The secure service 104 is in turn connected to the voice processing system 102 for initially authenticating the users and thereafter to provide speech recognition capability for user voice commands during a telephone banking session. According to the illustrated embodiment, the voice processing system 102 is connected to the secure service 104 over a communications network in the form of a public-switched telephone network 108.

Further Detail of System Configuration

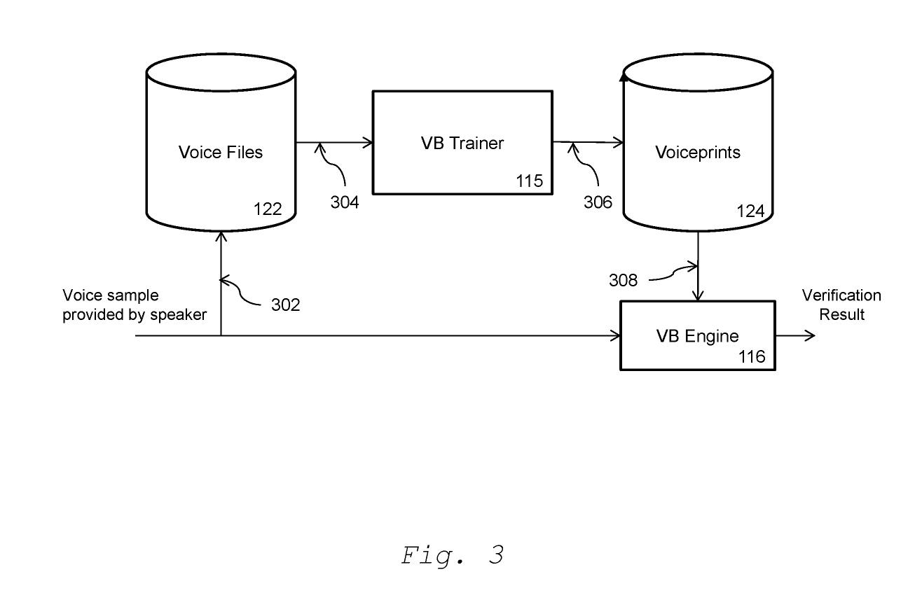

With reference to FIG. 2, the voice processing system 102 comprises a server computer 105 which includes typical server hardware including a processor, motherboard, random access memory, hard disk and a power supply. The server 105 also includes an operating system which co-operates with the hardware to provide an environment in which software applications can be executed. In this regard, the hard disk of the server 105 is loaded with a processing module 114 which, under the control of the processor, is operable to implement various voice authentication and speech recognition functions. As illustrated, the processing module 114 is made of up various individual modules/components for carrying out the afore-described functions, namely a voice biometric trainer 115, voice biometric engine 116, automatic speech recognition trainer 117 and automatic speech recognition engine 118.

The processing module 114 is communicatively coupled to a number of databases including an identity management database 120, voice file database 122, voiceprint database 124 and speech recognition model and grammar database 126. A number of personalised speech recognition model databases 128a to 128n may also be provided for storing models and grammar that are each tailored to a particular user's voice. A rule store 130 is provided for storing various rules implemented by the processing module 114, as will be described in more detail in subsequent paragraphs.

The server 105 includes appropriate software and hardware for communicating with the secure service provider system 104. The communication may be made over any suitable communications link, such as an Internet connection, a wireless data connection or public network connection. In an embodiment, user voice data (i.e. data representative of speech samples provided by users during enrolment, authentication and subsequent interaction with the secure service provider system 104) is routed through the secure service provider 104. Alternatively, the voice data may be provided directly to the server 105 (in which case the server 105 would also implement a suitable call answering service).

As discussed, the communication system 108 of the illustrated embodiment is in the form of a public switched telephone network. However, in alternative embodiments the communications network may be a data network, such as the Internet. In such an embodiment users may use a networked computing device to exchange data (in an embodiment, XML code and packetised voice messages) with the server 105 using a network protocol, such as the TCP/IP protocol. Further details of such an embodiment are outlined in the international patent application PCT/AU2008/000070, the contents of which are incorporated herein by reference. In another alternative embodiment, the communication system may additionally comprise a third or fourth generation (“3G”), CDMA or GPRS-enabled mobile telephone network connected to the packet-switched network, which can be utilised to access the server 105. In such an embodiment, the user input device 102 includes wireless capabilities for transmitting the speech samples as data. The wireless computing devices may include, for example, mobile phones, personal computers having wireless cards and any other mobile communication device which facilitates voice recordal functionality. In another embodiment, the present invention may employ an 802.11 based wireless network or some other personal virtual network.

According to the illustrated embodiment the secure service provider system 104 is in the form of a telephone banking server. The secure service provider system 104 comprises a transceiver including a network card for communicating with the processing system 102. The server also includes appropriate hardware and/or software for providing an answering service. In the illustrated embodiment, the secure service provider 104 communicates with the users over a public-switched telephone network 108 utilising the transceiver module.

Voiceprint Enrolment

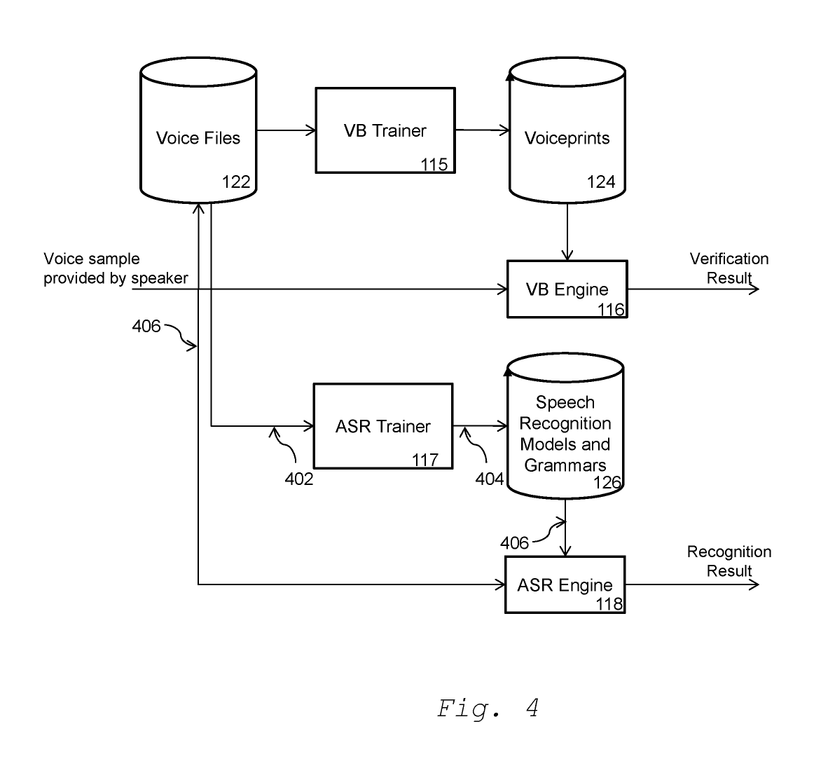

Before describing techniques for creating speech recognition models in any detail, a basic process flow for enrolling speech samples and generating voiceprints will first be described with reference to FIG. 3. At step 302 a speech sample is received by the voice processing system 102 and stored in the voice file database 122 in a suitable file storage format (e.g. a way file format). The voice biometric trainer 115 processes the stored voice file at step 304 for generating a voiceprint which is associated with an identifier for the user who provided the speech sample. The system 102 may request additional speech samples from the user until a sufficient number of samples have been received for creating an accurate voiceprint. Typically, for a text-dependent implementation (i.e. where the text spoken by the user must be the same for enrolment and verification) three repeats of the same words or phrases are requested and processed so as to generate an accurate voiceprint. In the case of a text-independent implementation (i.e. where any utterance can be provided by the user for verification purposes), upwards of 30 seconds of speech is requested for generating an accurate voiceprint. Voiceprint quality may, for example, be measured using the process described in the granted Australian patent 2009290150 to the same applicant, the contents of which are incorporated herein by reference. At step 306 the voiceprint is loaded into the voiceprint database 124 for subsequent use by the voice biometric engine 116 during a user authentication process (step 308). The verification samples provided by the user during the authentication process (which may, for example, be a passphrase, account number, etc.) are also stored in the voice file database 122 for use in updating or “tuning” the stored voiceprint associated with that user, using techniques well understood by persons skilled in the art.

Creating Generalised Speech Recognition Models

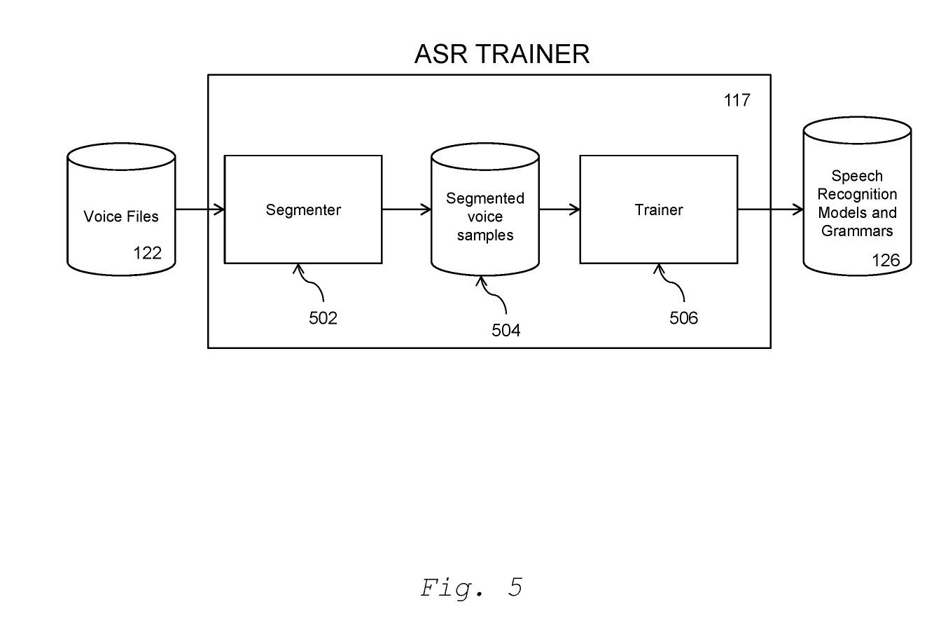

With reference to FIG. 4, there is shown an extension of the enrolment process which advantageously allows for automatic creation of generalised speech recognition models for speech recognition capability, based on the enrolled voice files. At step 402 a stored voice file (which may either be a voice file provided during enrolment, or a voice file provided post successful authentication) is passed to the ASR trainer 117 which processes the voice file to generate acoustic models of speech units associated with the voice file, as will be described in more detail in subsequent paragraphs. The acoustic models, which are each preferably generated from multiple voice files obtained from the voice file database 122, are subsequently stored in the speech recognition model database 126 at step 404. The models may subsequently by used at step 406 to provide automatic speech recognition capability for users accessing the secure service 104.

In more detail, and with additional reference to FIG. 5, the acoustic model generating step 402 comprises breaking the voice files up into speech units (also referred to as components) of the desired type of speech unit using a segmenter module (502). According to the illustrated embodiment, the different types of speech unit processable by the segmenter module 502 include triphones, diphones, senomes, phonemes, words and phrases, although it will be understood that any suitable unit of speech could be processable depending on the desired implementation. The segmenter module 502 assigns a start point for the speech unit and a finish point for the speech unit. The segmenter module 502 may be programmed to identify the finish point as the start point for the following speech unit. Equally, the segmenter module 502 may be programmed to recognise a gap between the finish of one speech unit and the start of the following speech unit. The waveform in the gap is herein referred to as “garbage” and may represent silence, background noise, noise introduced by the communications channel or a sound produced by the speaker but not associated with speech, such as breath noises, “ums”, “ars”, hesitations and the like. Such sounds are used by the trainer 506 to produce a special model that is commonly referred to in the art as a “garbage model” or “garbage models”. The garbage models are subsequently used by the recognition engine 126 to recognise sounds heard in the speech samples but which are not a predefined speech unit. The segmented non-garbage speech units are stored at step 504 in association with an audible identifier (hereafter “classifier”) which is derived from speech content data associated with the original speech sample. For example, the voice processing system may store metadata that contains the words or phrases spoken by a user during enrolment (e.g. their account number, etc.). A phonetic look-up dictionary may be evaluated by the segmenter 502 to determine the speech units (triphones, diphones, senones or phonemes) that make up the enrolled word/phrase. Generalised or prototype acoustic models of the speech units are stored in the segmenter 502 and used thereby to segment the speech provided by the user into its constituent triphones, diphones, senones or phonemes parts. Further voice files are obtained, segmented and stored (step 504) until a sufficient number of samples of each speech unit have been obtained to create a generalised speech model for the classified speech unit. In a particular embodiment, between 500 and 2,000 samples of each triphone, diphone, senone or phoneme part is required to produce a generalised acoustic model for that part suitable for recognition. According to the illustrated embodiment, as new voice files are stored in the database 122 they are automatically processed by the ASR trainer 117 for creating and/or updating acoustic models stored in the model database 126. Typically between 500 and 2,000 voice files are obtained and processed before a model is generated in order to provide a model which will sufficiently reflect the language and accent of the enrolled users. The speech units are subsequently processed by a trainer module 506. The trainer module 506 processes the segmented speech units spoken by the enrolled speakers to create the acoustic models for each of the speech units required by the speech recognition system, using model generation techniques known in the art. Similarly, the training module 506 also compiles the grammars and language models from the voice files associated with the speech units being used by the speech recognition. The grammars and language models are computed from a statistical analysis of the sequences of triphones, diphones, senones, phonemes, word and/or phrases in the speech samples, that is denoting the probability of a specific triphone, diphone, senone, phonemes, word and/or phrase being followed by another specific triphone, diphone, senone, phoneme, word and/or phrase. This way the acoustic models, grammars and language models are implemented specific to the way the speakers enrolled in the system and therefore specific to the accent and language spoken by the enrolled speakers. The generated models and embedded grammar are stored in the database 126 for subsequent use in providing automatic speech recognition to users of the secure service 104.

In an embodiment, certain rules are implemented by the processing module 114 which specify the minimum number of speech unit samples that must be processed for model creation. The rules may also specify a quality for a stored model before it will be utilisable by the processing module 114 for recognising speech. In a particular embodiment, for each classifier there may exist a male and female gender model. According to such an embodiment, the rules may provide that only speech samples from male users are selected for creating the male models and female users for creating the female models. This may be determined from metadata stored in associated with the known user, or by way of an evaluation of the sample (which involves acoustically processing the sample employing both female and male models and determining the gender based on the resultant authentication score i.e. a higher score with a male model denotes a male speaker, while a higher score using the female model denotes a female speaker). Additional or alternative models may equally be created for different language, channel medium (e.g. mobile phone, landline, etc.) and grammar profiles, such that a particular model set will be selected based on a detected profile for a caller. The detected profile may, for example, be determined based on data available with the call (such as telephone line number or IP address which would indicate which profile most closely matches the current call), or by processing the speech using a number of different models in parallel and selecting the model that generates the best result or fit (e.g. by evaluating the resultant authentication score).

Creating Personalised Speech Recognition Models

Once a user has been successfully authenticated they are considered ‘known’ to the system 102. In a particular embodiment, once a user is known a personalised set of models can be created and subsequently accessed for providing greater speech recognition accuracy for that user.

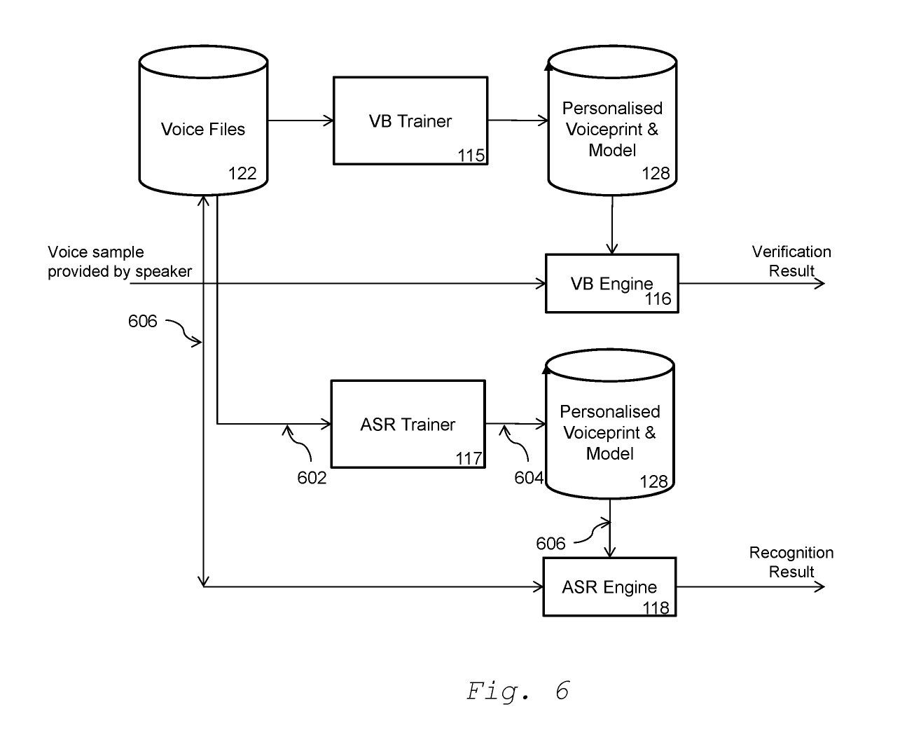

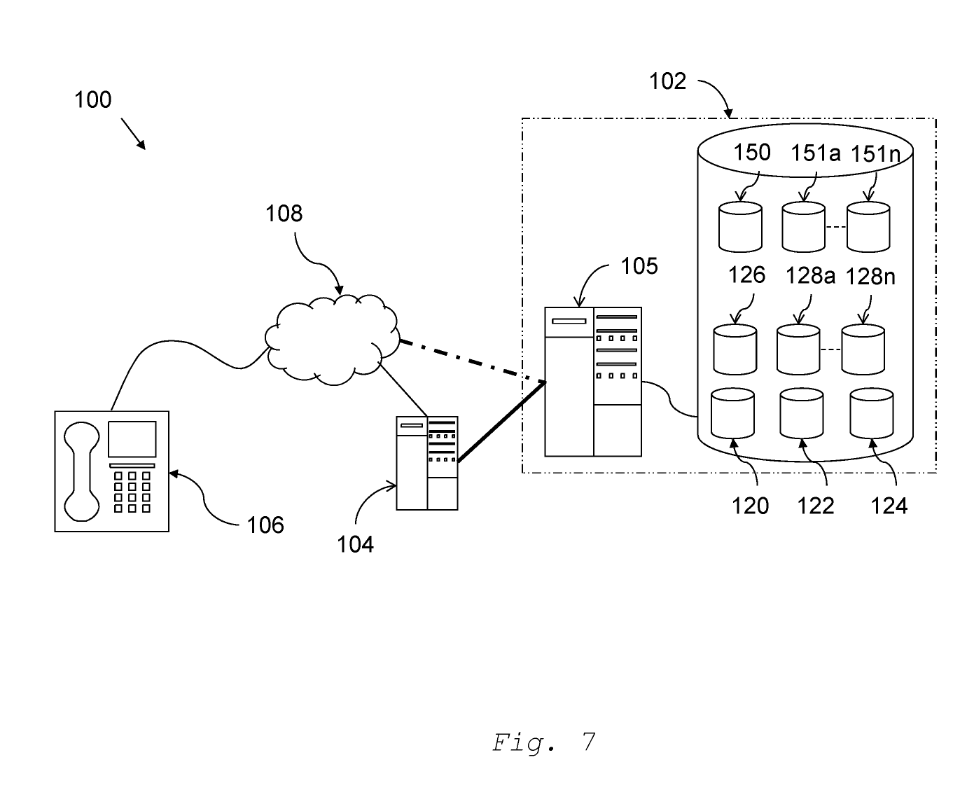

According to such an embodiment, and with additional reference to FIG. 6, a personalised voiceprint and speech recognition database 128 is provided for each user known to the system (see steps 602 to 606). The models may be initially configured from speech samples provided by the user during enrolment (e.g. in some instances the user may be asked to provide multiple enrolment speech samples for example stating their account number, name, pin number, etc. which can be processed for creating a limited number of models), from generic models as previously described, or from a combination of the two. As new speech samples are provided by the user new models can be created and existing models updated, if required. It will be appreciated that the new samples may be provided either during or after successful authentication of the user (e.g. resulting from voice commands issued by the user during the telephone banking session). The user may also be prompted by the system 102 to utter particular words, phrases or the like from time to time (i.e. at step 602) to assist in building a more complete set of models for that user. Again, this process may be controlled by rules stored in the rule store 130.

Although embodiments described in preceding paragraphs described the processing system 102 in the form of a “third party”, or centralised system, it will be understood that the system 102 may instead be integrated into the secure service provider system 104.

Alternative configuration and methodology may include the collection of speech samples by speakers using third party speech recognition function such as the “Siri” personal assistant (as described in the published United States patent application no. 20120016678 assigned to Apple Inc.), or “Dragon” speech recognition software (available from Nuance Communications, Inc. of Burlington, Mass.) integrated into a smart phone or other computing device which is used in conjunction with a voice authentication system as described herein. In this case the speech samples from the “known” speaker can be stored in the voice files database 122 and then used by the segmenter module 502 and trainer module 506 to create speech recognition models for that speaker using the process described above.

Embodiments of the invention can be extended to include user specific models that describe the acoustic nature of sentiment or emotional state, also expressed in the user's voice signal.

It is well known that a person's emotional state can be expressed by the specific words they use and the qualities of their voice. Further the way an individual expresses an emotional state can be specific to their personal, linguistic and cultural backgrounds.

For example, a person with a certain linguistic and cultural background may use the word “damn” for expressing both delight, anger and frustration. What is more, the acoustic attributes associated with the way a person says a specific word or phrase will also differ depending on their emotional state and the intent they wish to express. An embodiment of the present invention can associate with each speaker one or more acoustic; grammar and language models that characterise different emotional states.

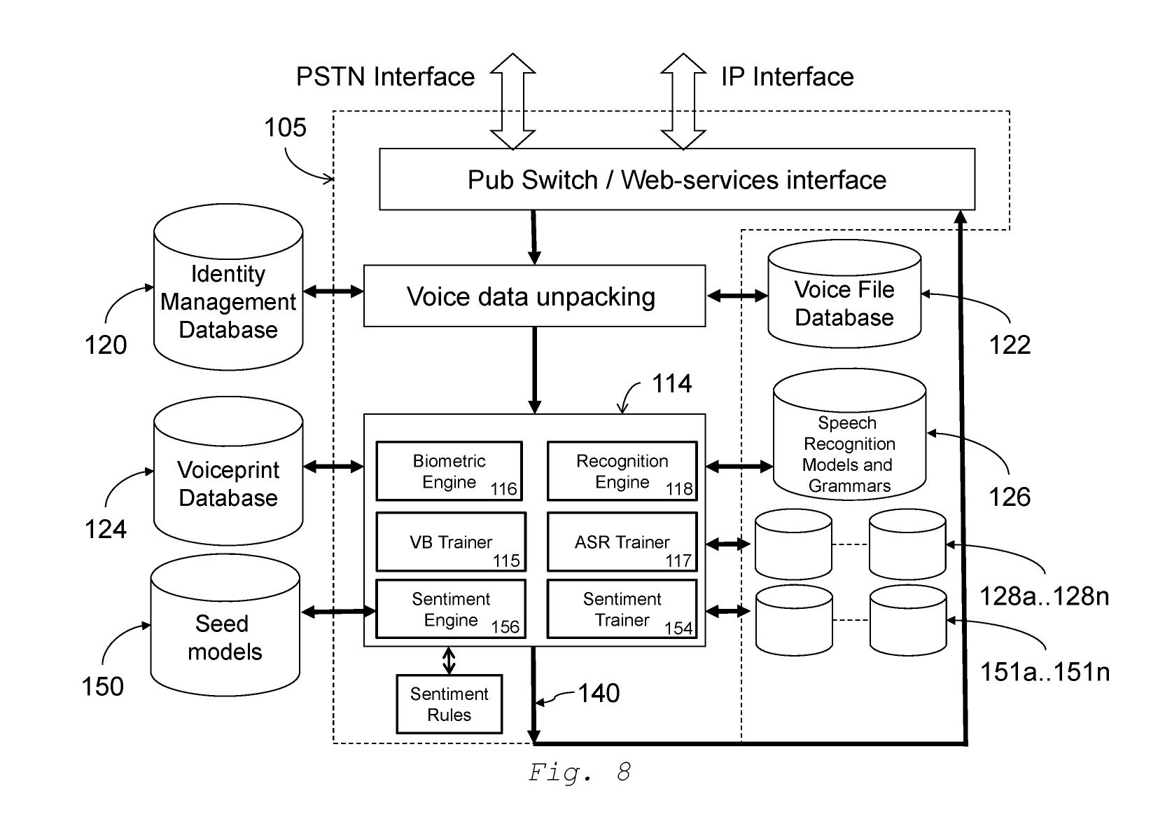

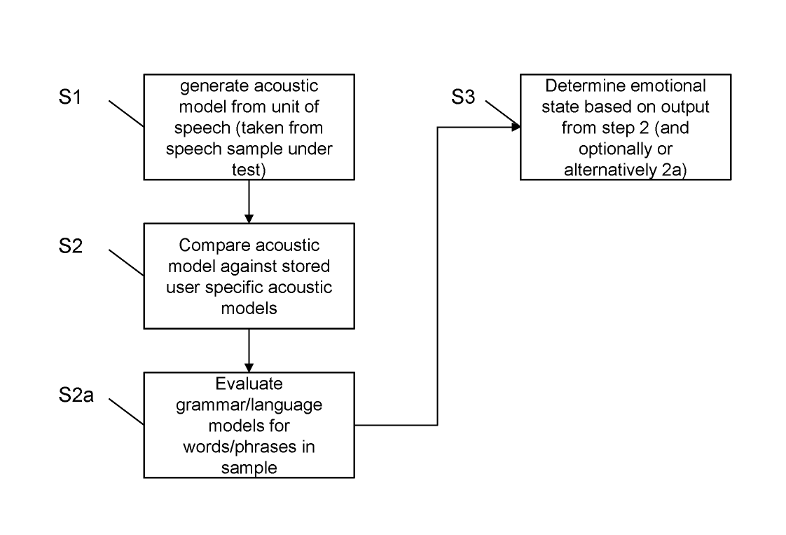

With reference to FIGS. 7 to 9 there is shown a system and process flow for implementing such an embodiment.

According to such an embodiment, a database of speech samples is collected for emotional state classification. The samples may, for example, be classified with a predefined emotional state, such as angry, delighted, frustrated or neutral. Classification can be performed manually by listening to each of the samples and assigning an emotional state to the samples using a trained listener.

Alternatively, classification can be automatically determined using a scoring system. For example, in a particular embodiment, the system may make use of a Net Promotor Score (NPS), commonly used in call centres for enabling callers to assess their satisfaction with the level of services they have received from their interaction with a call centre service. The higher the NPS the more pleased or happy the caller is with the services provided. Low Net Promotor Score may indicate angry and dissatisfied speakers. Thus, as an initial classification step, speech samples derived from calls that have been assigned a high NPS score may be associated, for example, with one or more of a “pleased” or “happy” state, whereas samples derived from calls having a low NPS score may be associated with one or more of an “unhappy”, “angry” or “frustrated” state.

The recognition engine 118 then process the samples to identify words and phrases commonly used to express the classified emotional states. For example, the phrase “that's fine” or “I am pleased with that” may be associated with a pleasurable experience and may be present in a large number of samples having high Net Promotor Scores. The output is then input into a sentiment trainer implementing an algorithm for generating generalised grammar and/or language models associated with each classified emotional state (i.e. compiled based on an analysis of all the input samples). As an alternative, the grammar models may initially be derived from a database of words and/or phrases that are commonly used to represent a particular state. The grammar models may thus be generated so that they reflect sequences of phonemes or words (depending on the desired configuration) that are commonly used to reflect the corresponding emotional state. Similarly, language models may be generated from speech samples that are characterised as having a known emotional state and taken from users having a known language or dialect.

The classified speech samples are also input into the sentiment trainer 154 for creating a general acoustic model for individual units of speech (i.e. derived from the speech samples) for associating with the classified emotional state. For example, an angry call may contain stressed or trembling speech; shouting or exasperated noises. These vocal characteristics are captured by the acoustic model for that emotional state.

Together (and separately) the acoustic, grammar and language models describe the emotional state for a population of speakers and as such represent the “seed” emotional state models. These models are subsequently stored in a seed database 150.

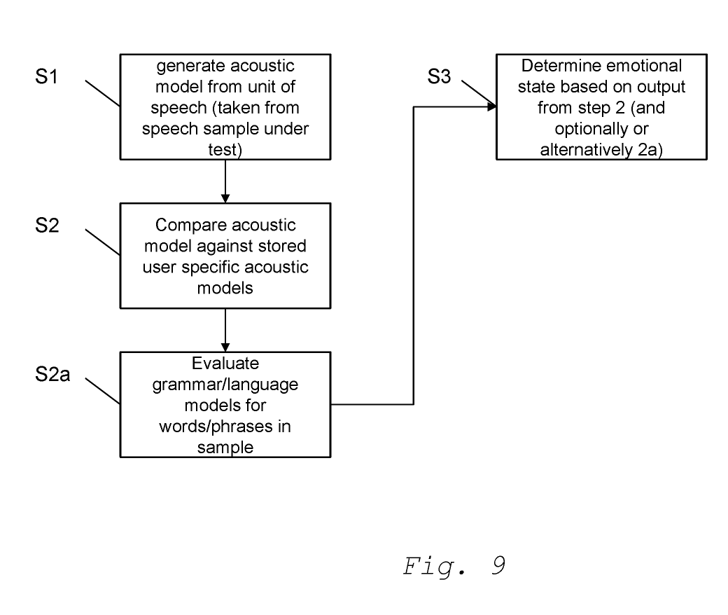

Similar to the speaker specific speech recognition models, the seed models are then associated with each speaker voiceprint enrolled in the system and stored in respective databases 151a to 151n. As each speaker users the system and is verified by their voice biometric voiceprint so it is that their emotional state is assessed by the sentiment models. This process is outlined below in more detail with reference to FIG. 9.

At step S1 the sentiment engine 156 compares a unit of speech from a speech sample under test (e.g. provided during a speech recognition session) to generate a corresponding acoustic model. At step S2, the generated model is then compared against each model stored in the personalised acoustic model (stored in database 151) for that individual user. At step S3, the resultant scores are then evaluated by the engine 156 and a positive determination of emotional state is made for models having a comparison score which either met or exceeded a threshold predefined by the system.

In addition, or as an alternative to steps S1 and S2, the recognition engine 118 may parse the sample under test to identify phonemes, words and/or phrases with the sample. These are then compared against the stored grammar and/or language models to see whether there is a match (i.e. by evaluating the resultant scores which are representative of how likely the sequence of phonemes/words/phrases derived from the sample match a grammar model for a particular emotional state). In a particular embodiment, an emotional state is positively determined when the emotional state determined from the acoustic model comparison (as outlined above) also scores highly (i.e. meets or exceeds a predefined threshold score) for a grammar and/or language model associated with the same emotional state.

Having identified the emotional state(s) of the user, a sentiment business rules engine 140 may then select the most appropriate response for the user.

By way of example, various key words and phrases associated with frustration and anger may be detected by the word/phrase grammar. Further, a score associated with the acoustic models for frustration and anger are also high. These scores indicate that the speaker may be expressing anger and, hence, an appropriate response to the speaker is selected by the system to acknowledge their anger. Further, if the angry sentiment is confirmed, then that speaker angry voice sample can be used to re-train the corresponding personalised acoustic, grammar and/or language models. The confirmation may be done manually (e.g. by a trained listener reviewing the sample), or alternatively by way of an automated response asking the user to confirm the emotional state (e.g. “I detect that you are angry is this correct?”). If the sentiment is not confirmed, then the response can be further modified to re-interpret the speaker sentiment (e.g. “OK, please tell me how you are feeling”). The speech recognition process may then process the speech sample to identify the emotional state the user uttered in their response. As the enrolled speakers access the system, the personalised models may be continuously updated by the sentiment engine 156 to improve their quality (i.e. how accurately they represent that user's emotional state). For example, when a predefined number of positive emotitional state confirmations have been determined by the system, the engine 156 may determine that the models accurately reflect the user's emotional state and cease re-training.

The sentiment business rules 140 can also be configured to iterate towards a happier or more delighted emotional state. The emotional state of subsequent voice samples can be measured (e.g. by assigning a score to each emotional state, such that a low score is assigned, for example, to an angry or frustrated state, whereas a high score is assigned to a happy or pleased state) to determine that a happier or more pleased emotional state outcome is being consistantly achieved. This way the system can learn through configurable business rules 140 the appropriate responses for different emotional states as expressed by each speaker enrolled in the system with the objective that the system will select responses that elicits a “happier” or more delighted measure of emotional state.

Alternatively, speech samples collected by a host or cloud service, such as a hosted IVR service or a cloud based voice processing system, used in conjunction with a voice authentication system, could also be used to create the speech recognition models using the methodology described herein.

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for configuring a speech recognition system, the method comprising:
identifying a user;
selecting a training speech sample provided by the user, the training speech sample being associated with an emotional state of the user;
processing a selected unit of speech from the training speech sample to generate a corresponding acoustic model;
training a personalised acoustic model associated with the determined emotional state using the generated acoustic model, the personalised acoustic model being stored in an acoustic model store specific to the user;
accessing the personalised acoustic model store to determine an emotional state of the user during a subsequent speech recognition process.

2. A method in accordance with claim 1, wherein the personalised acoustic model is initially derived from a seed model.

3. A method in accordance with claim 1, further comprising implementing an authentication process for identifying the user, the authentication process being implemented by an authentication system.

4. A method in accordance with claim 3, wherein the training speech sample is provided by the user either during enrolment with the authentication system or during a subsequent authentication process carried out by the authentication system.

5. A method in accordance with claim 3, wherein the training speech sample is provided by the user during a speech recognition process that is implemented by the speech recognition system once the user has been authenticated.

6. A method in accordance with claim 1, wherein the subsequent speech recognition process comprises:
generating an acoustic model for a unit of speech derived from a speech sample uttered by the user during the subsequent speech recognition process;
comparing the acoustic model against one or more models stored in the personalised acoustic model store to generate respective comparison scores representative of how closely matched the models are; and
determining one or more emotional state(s) of the user based on the resultant scores.

7. A method in accordance with claim 6, wherein an emotional state is positively determined where the comparison score for the associated model meets or exceeds a predefined threshold.

8. A method in accordance with claim 1, further comprising accessing a personalised grammar model store associated with the user and training one or more grammar models associated with the determined emotional state using phonemes or words from the training speech sample

9. A method in accordance with claim 8, wherein the grammar models are evaluated in addition to the personalised acoustic models for determining the emotional state of the user during the subsequent speech recognition process.

10. A method according to claim 1, further comprising updating the personalised acoustic model store based on acoustic models generated from further processed speech samples uttered by the user.

11. A method in accordance with claim 10, further comprising determining a quality measure for each of the acoustic models stored in the personalised acoustic model store and continuing to update the acoustic modules until the quality measure reaches a predefined threshold.

12. A computer readable medium implementing a computer program comprising one or more instructions for controlling a computer system to implement a method in accordance with claim 1.

13. A method for configuring a speech recognition system, the method comprising:
identifying a user;
selecting a training speech sample provided by the user, the training speech sample being associated with an emotional state of the user;
processing the training speech sample to determine one or more phonemes or words therein;
training a personalised grammar model associated with the determined emotional state utilising the determined phonemes or words, the personalised grammar model being stored in a model store specific to the user;
accessing the personalised grammar model store to determine an emotional state of the user during a subsequent speech recognition process.
